(19) United States
(12) Patent Application Publication
(10) Pub. No.: US 2009/0129104 A1
(43) Pub. Date: May 21, 2009

(54) Floor mat

(75) Inventors: Takeo Shimano, Saitama (JP); Toshimitsu Kohinata, Saitama (JP); Toshiaki Ushikubo, Saitama (JP)

Correspondence Address: HAMRE, SCHUMANN, MUELLER & LARSON, P.C., P.O. BOX 2902, MINNEAPOLIS, MN, 55402-0902, US

(73) Assignee: SANRITZ CORPORATION, Itabashi-ku (JP)

(21) Appl. No.: 11/658,962

(22) PCT Filed: Jan. 26, 2005
(86) PCT No.: PCT/JP2005/001435

§ 371 Date: Jan. 30, 2007

(30) Foreign Application Priority Data
Aug. 4, 2004 (JP) 2004-227709

(51) Int. Cl. B60Q 3/02

(52) U.S. Cl. 362/459

(57) ABSTRACT

A conventional room lamp or foot lamp has a problem that the place where user's feet are is difficult to see and poor in visibility, and on the other hand, when the lamp is made unnecessarily bright to cause luminance distribution in the field of view to be discontinuous, an unpleasant phenomenon called glare occurs. A surface EL light emitting body is entirely coated with a transparent waterproof sheet and then it is sandwiched and bonded between upper and lower sheets to form on mat. At least a part of the upper sheet is formed transparent, a lead wire is fixed to the EL light emitting body, and a connector to be connected to a power supply outlet in a vehicle is provided at the forward end of the lead wire. A light control circuit for altering the emission intensity of the EL light emitting body and a circuit for automatically turning off the power upon disconnection of the lead wire are provided in the middle of the lead wire, and the EL light emitting body is made to emit light at a luminance of 0.5-4.0 cd/m².

### TECHNICAL FIELD

The present invention relates to a floor mat provided with a lighting function to illuminate the floor or the aisle in motorcar or train vehicles for providing light around passenger's feet.

### BACKGROUND ART

Conventional vehicles generally have a variety of lighting apparatuses such as a room light and a door lamp aimed at lighting up about passenger's hands and feet, thereby ensuring security for getting on and off a vehicle as well as improving passenger usability

Disadvantageously, however, such a room light cannot provide sufficient light around passenger's feet. Similarly, a foot lamp that is specially designed for lighting up passenger's feet is usually mounted to shine down, making some dark comers difficult to see by shadows of passenger's own feet or a seat. At the same time, excessive light around one's feet causes so-called discomfort glare due to a discontinuous brightness distribution.

### DISCLOSURE OF INVENTION

Present invention can solve the problems by providing sufficient visibility with conventional room lights or foot lamps of dark comers or so-called discomfort glare of excessive light due to the discontinuous brightness distribution around one's feet

### MEANS FOR SOLVING THE PROBLEMS

According to claim 1 the present invention provides a floor mat comprising: a sheet of mat formed with a plane electro luminescent body covered with a waterproof sheet and placed between an upper sheet and a lower sheet hermetically sealed together, said upper sheet being at least partially transparent; and a lead fixed to said electro luminescent body and provided with a connecting member at its end to be connected to a power source outlet in a vehicle; a light control circuit for controlling a luminescence intensity of said electro luminescent body; and an automatic circuit breaker for automatically cutting off electric current when said lead is disconnected.

According to claim 2, said upper sheet is provided with a design.

According to claim 3, said electro luminescent body is capable of illuminating light at luminance of 0.5-4.0 cd/m².

### BRIEF DESCRIPTION OF DRAWINGS

FIG. 1 shows a cross sectional view of a floor mat according to the present invention.

FIG. 2 shows a perspective view of the floor mat.

FIG. 3 shows a circuit diagram in a box of the floor mat.

### DETAILED DESCRIPTION OF THE PREFERRED EMBODIMENT

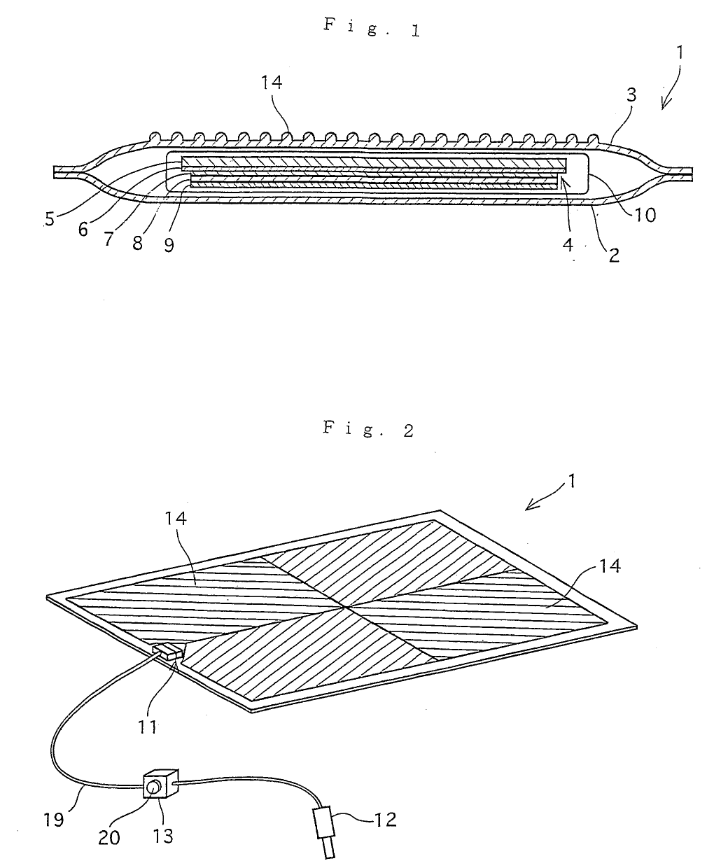

FIG. 1 shows a cross sectional view of a floor mat according to the present invention. The floor mat 1 is formed with an electro luminescent body 4 placed between a lower sheet 2 and an upper sheet 3. The lower sheet 2 has flexibility and its base surface is provided with non-slip finishing. The upper sheet 3 is made of a transparent or semi-transparent material having flexibility and elasticity with many projecting lines 14 formed on its surface. The projecting lines 14, formed as a part of the upper sheet 3 with the same material, are the parallel lines each shaped of semi-cylinder.

The electro luminescent body 4 comprises a film 5 made of PET (polyethylene terephthalate) that is laminated with a transparent electrode 6 e.g. ITO(indium tin oxide), a luminescent layer 7, an insulating layer 8, and a backside electrode 9 in this order.

The luminescent layer 7 is either a dispersion type which is formed with powdered luminescent materials mixed in a high dielectric binder or a thin film type which is formed with thinned luminescent materials by way of vapour deposition or the like.

This electro luminescent body 4 is covered and sealed with a waterproof sheet 10, and then placed between the lower sheet 2 and the upper sheet 3 whose margins adhered together.

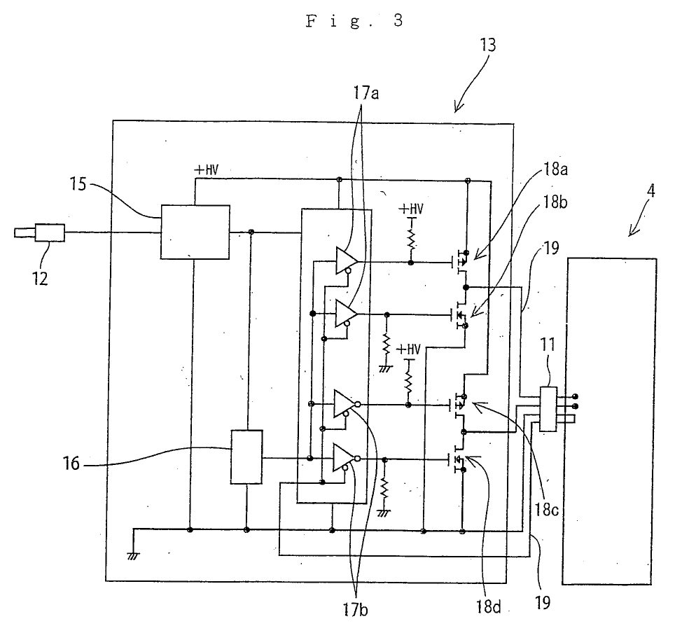

FIG. 2 shows a perspective view of the floor mat 1. The floor mat 1 has a connector 11 on its end portion. The connector 11 is linked with a lead (no fig.), which is pulled out from the transparent electrode 6 and the backside electrode 9 of the electro luminescent body 4 without spoiling a sealing performance of the waterproof sheet 10, and linked by the connector 11 to the lead 19. The lead 19 has a cigar lighter plug 12 to be plugged into a cigar lighter socket of a vehicle, and a power switch (no fig.) at its end.

The lead 19 is further provided with a box 13 in the middle of the length. The box 13 builds in a dial 20 for adjusting luminescence intensity of the electro luminescence body 4 and a circuit breaker for automatically cutting off power supply in case the lead 19 is disconnected or the connector 11 is loosened. The upper sheet 3 is divided into 4 (2×2) blocks and each block has the projecting lines 14 in parallel.

FIG. 3 shows a circuit diagram in the box 13. A linear regulator 15 controls a direct-current voltage from the socket 12 plugged in the cigar lighter socket and provides a high voltage (+HV) to illuminate the electro luminescence body 4 and a logic supply for inner control to illuminate the electro luminescence body 4. The +HV voltage for the electro luminescence body 4 is controlled by the three state buffer 17a, 17b and FET 18a˜18d operated by the signals of an oscillator 16

The three-state buffer 17a output low or high to the input signal of low or high while the three-state buffer 17b output high or low to the input signal of low or high. FET 18a and 18c are the P-channel FET being on if the gate voltage is low, while FET 18b and 18d are the N-channel FET being on if the gate voltage is high.

Therefore if the signal of the oscillator 16 is low, the output of the three-state buffer 17a is low and the gate voltage of FET 18a and 18b is low, FET 18a is on, FET 18b is off, output of the three-state buffer 17b is high and the gate voltage of FET 18c and 18d is high, FET 18c is off, FET 18d is on. Currency runs from FET 18a through the electro luminescence body 4 toward FET 18d. If the signal of the oscillator 16 is high, the output of the three-state buffer 17a is high and the gate voltage of FET 18a and 18b is high, FET 18a off, FET 18b on, output of the three-state buffer 17b low and the gate voltage of FET 18c and 18d low, FET 18c on FET 18d off. Currency runs from FET 18c through the electro luminescence body 4 toward FET 18b. With this circuit, the square wave voltage oscillating double of +HV is added to the electro luminescence body 4

Furthermore the gate of the three-state buffer 17a, 17b is connected to GND through the connector 11 and the electro luminescence body 4. If the connector 11 is suddenly unplugged or the lead 19 for supplying power is cut, the connection between the gate of the three-state buffer 17a, 17b and GND is disconnected, output of the three-state buffer 17a, 17b becomes high impedance, and the gate voltage of FET 18a˜18d relies on the electric potential connected through the resistance, all of FET 18a˜18d become off and circuit closes to be disengaged.

The floor mat 1 is made to produce plane emission at low illumination intensity of 0.5-4.0 cd/m². The amount of light that will not be a destruction for a driver while driving is around 1 cd/m². The luminance below 0.5 cd/m² is too dark as lighting for visibility around one's feet, whereas the luminance over 4.0 cd/m² coming up from floor will be a driver's destruction.

The floor mat 1 constructed as described above is capable of plane emission at low illumination intensity of 0.5-4.0 cd/m² for providing an appropriate amount of light around one's feet in a vehicle: It can widely provide required light without causing brightness contrasy as well that it can gain a sufficient lighting effect without destructing a driver even when light is emitted while driving.

More advantageously, the floor mat 1 of the size of A3 only needs electricity of about 0.5 W. The floor mat 1 further comprises a control circuit consisting of the three state buffer 17 which closes the gate 18 of the FET to shut the current flow in case the lead 19 is disconnected or the connector 11 is loosened, thereby eliminating the danger of electric leakage.

The electro luminescence body 4 is easy to maintain, since it is hermetically covered with the waterproof sheet 10 and so washable with water when get dirty. It becomes more easy to use if the lower sheet 2 and the upper sheet 3 are made of flexible materials so that they can be adjusted to the shape of the floor of a vehicle.

Additionally, due to the lens effect of many semi-cylinder projecting lines 14 formed on the upper sheet 3, decorativeness by the light and shadow is available and if trodden, the projecting lines 14 can decrease the shock toward the electro luminescence body 4.

Alternatively, hemisphere shock absorbers (no fig.) can be used instead of the semi-cylinder projecting lines 14. A power supply plug for general power source outlets can substitute the cigar lighter plug 12 to be plugged into a cigar lighter socket. A connector for general outlets is also applicable to the cigar lighter plug 12. If it is possible to connect the plug 12 to general power source outlets, it enables the floor mat 1 being used domestically or commercially.

The floor mat 1 can be also provided with a decoration by presenting designs such as an emblem, writings or curving of letters, and the like on the upper sheet 3.

The floor mat 1 with decorations such as designs or writings is used for emergency exits or shop advertisement and also has advertising effects when placed on corridors of shops etc. along with other conventional advertising signs.

A sensor can be optionally attached toward opening/closing the door of the vehicle or building to make the floor mat 1 light, for example, a shifting sensor to sense the shifting of the door and let the floor mat 1 light when the door opens.

With the sensor of opening/closing the door for the lightning of floor mat 1, it is possible to light the foot area entering dark room or vehicle and it ensures security for getting on and off a vehicle.

### INDUSTRIAL APPLICABILITY

According to claim 1 of the present invention, a flexible floor mat formed with a plane electro luminescent body can fit the shape of the floor of a vehicle and the brightness is appropriate. According to claim 2 of the present invention, said electro luminescent body is capable of illuminating light at luminance of 0.5-4.0 cd/m² providing necessary light without causing excessive contrast of the brightness.

The floor mat 1 according to the present invention can be used not only in motorcar or train vehicles on their floor or aisle, but also in buildings at places such as a corridor, an entrance, and a fire exit to light up passenger's feet.

1. A floor mat for a vehicle comprising: a sheet of mat formed with a plane electro luminescent body covered with a waterproof sheet and placed between an upper sheet and a lower sheet hermetically sealed together, said upper sheet being transparent or partially transparent forming plurality of projecting lines shaped of semi-cylinder on the surface; the lead fixed to said electro luminescent body and provided with a connecting member at its end to be connected to a power source outlet in a vehicle; a light control circuit for controlling a luminescence intensity of said electro luminescent body; and an automatic circuit breaker being connected between said connecting member and electro luminescent body for automatically cutting off electric current when said lead is disconnected.

2. The floor mat for a vehicle according to claim 1, wherein said upper sheet is provided with at least one of a design, a pattern and letters.

3. The floor mat for a vehicle according to claim 1, wherein said electro luminescent body is capable of illuminating light at luminance of 0.5-4.0 cd/m².
